(19) United States
(12) Patent Application Publication
(10) Pub. No.: US 2008/0046433 A1
(43) Pub. Date: Feb. 21, 2008

(54) Role template objects for network account lifecycle management

(75) Inventors: Eric C. Kool-Brown, Seattle, WA (US); Ronald R. Martinsen, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/504,844

(22) Filed: Aug. 16, 2006

(51) Int. Cl. G06F 17/30

(52) U.S. Cl. 707/9

(57) ABSTRACT

Described is a computer networking-related technology by which an association is maintained between network account objects (e.g., for network users, computers, services and so forth) and a role template object for those types of account objects. The network account objects for a role may be located based on the association, and an administrative function such as propagating changes, generating reports, monitoring and/or enforcing compliance with the role template object and so on may be performed on those associated network account objects. Action information, such as a set of URIs referencing workflow assemblies containing tasks to perform, may be maintained in the role template object. Upon the occurrence of a lifecycle event (e.g., creation, reassignment to another role template object or deletion) that occurs to an associated network account object, a defined action comprising one or more tasks may be automatically taken via the association with the role template object.

### BACKGROUND

In an enterprise having a computer network, most computer network users fall into specific categories that define their roles. For example, in a business, there may be computer users who can be classified as either managers, executives, sales personnel, marketing personnel, computer administrators, engineers, clerks, accounting personnel, payroll personnel or one of many other possible categories. In general, a given user's role often implies memberships in certain email distribution groups and other network facilities. Further, a user's role typically defines what network resources that user can access, and the degree of access (read-only, write, full, and the like) to those resources. Specific resources may be created for the user depending on that user's role, such as file shares, disk quotas, email accounts, and the like.

If a user's role is changed, then a different set of network resources and permissions are typically required. Such changes can include changing group memberships, changing application privileges, changing disk quotas, and so on. When an employee leaves the company, requiring deletion of the corresponding user account, any other network or application settings associated with that user also need to be handled. For example, in addition to removing that former employee's user account from the network, a company may have a policy to archive the email and documents of former employees.

Moreover, a role itself may evolve, requiring new or different accesses and capabilities for users holding that role. For example, an employment role may be given additional scope, such as to give sales people access to a marketing database, whereby changes need to be made to the existing user accounts that correspond to that role.

Such changed situations require that an administrator perform a number of tasks to match users' computing rights and needs with current roles. At present, such tasks can only be done on an ad hoc basis. Moreover, other types of network accounts, such as a network service account, and a network computer account may exist and have similar changes. For example, a computer system may have one role when first set up, move to another role as it ages, and need its account deleted when it is decommissioned.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an association is maintained between network account objects (e.g., account objects representing network users, network computers and network services, such as database or web services that similarly have group memberships and permissions) and a role template object for those types of account objects, e.g., via an identifier of the associated role template object maintained in each network account object that has an association. The network account objects for a role may be located based on the association, and an administrative function may be performed on those associated network account objects. For example, changes may be propagated to the network account objects, reports may be generated for those network account objects, and/or compliance of those network account objects with the role template object's attributes may be monitored/audited.

Further, action information may be maintained in the role template object that corresponds to a lifecycle event, such as creation, reassignment (moving the network account to a different role template object) or deletion of a network account object associated with the role template object. The action is taken in response to the lifecycle event occurring. For example, the action information may be maintained in the form of uniform resource identifiers (URIs) to a task set comprising one or more tasks (sometimes referred to as activities) that are run to take the action, such as contained in workflow assemblies, e.g., one or more for creation, one or more for moving and one or more for deleting.

In this manner, a plurality of network account objects may each be associated with at least one role template object. A template manager coupled to the role template objects causes a lifecycle event action to be taken in response to detection of a lifecycle event related to a network account object. Further, a search mechanism may locate which network account objects are associated with a selected role template object, e.g., based on an identifier of that selected role template object, whereby changes may be propagated to the network account objects that are associated with the selected role template object, reports may be generated for those network account objects that are associated with the selected role template object, and compliance with the settings of the role template object may be monitored, e.g., for auditing and/or for enforcing compliance.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a block diagram representing relationships between role template objects and user accounts comprising examples of network accounts represented by objects.

FIG. 3 is a block diagram representing a role template object and its attributes linked to by a given user account object, including attributes that point to workflows that perform lifecycle actions.

FIG. 4 is a representation of an object store containing role template objects, and network account objects that can be located by a role via their links to one (or more) of the role template objects.

FIG. 5 is a flow diagram showing an example of creating a user account object linked to a role, and then changing that user account object in response to lifecycle events or changes to the role to which the user account object is currently linked.

### DETAILED DESCRIPTION

Various aspects of the technology described herein are generally directed towards managing network account objects (sometimes referred to as security principals), wherein a network account object corresponds to a role and in general specifies the network access rights, privileges, resources and so forth for a given network entity such as a user, service or computer. Unlike past systems, in which a template was used to create a user account object and thereafter had no relationship with the user account object, various aspects of the technology described herein are directed towards maintaining an association between each network account object and a role template object (or template objects) after creation.

For purposes of simplicity herein, many of the various examples are directed towards one particular type of network account object, namely a user account object. Notwithstanding, it will be readily appreciated that this is only for example purposes, and that other network account objects, including but not limited to service account objects and computer account objects, are basically equivalent with respect to role template objects and/or lifecycle management.

In one example implementation, the network account objects and role template objects are maintained in an object store, which in an example implementation described herein, is an object store in a Microsoft® Active Directory® environment. Notwithstanding, it can be readily appreciated that the data of the objects described herein may be alternatively maintained in other data structures and/or data stores, and in other networking environments. Indeed, as used herein, the term “object” represents any data structure for maintaining data including attributes (equivalent to “properties” as used herein), and “object store” refers to any collection of objects, regardless of how they are physically and/or logically arranged and/or located. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and network management in general.

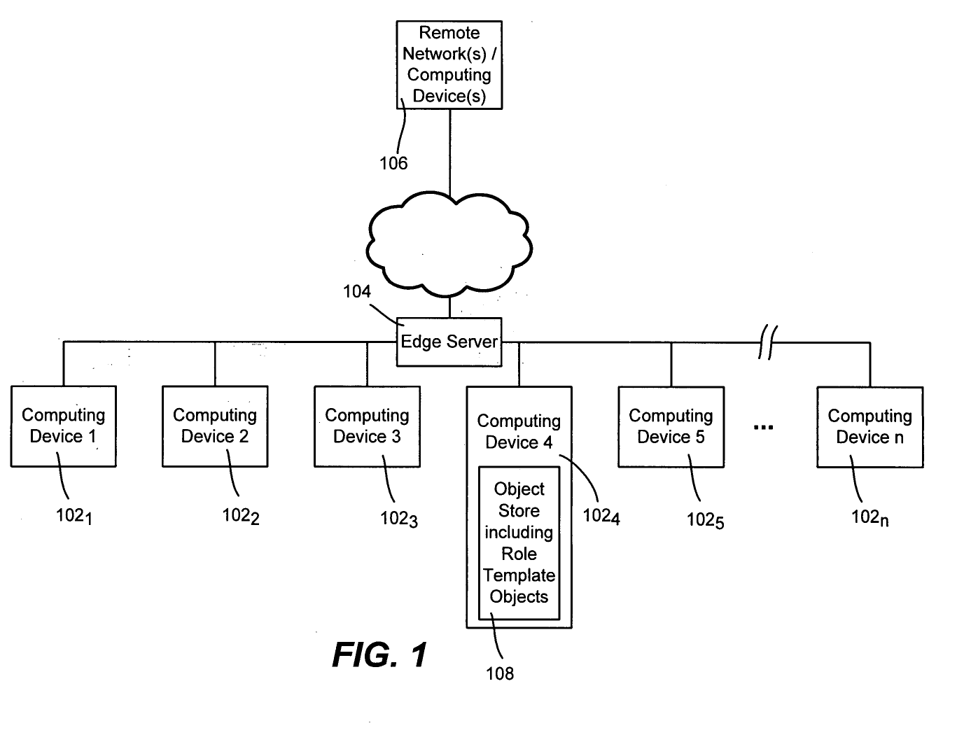

FIG. 1 shows an example network arrangement for a hypothetical enterprise, in which a number of computing devices 102₁-102ₙ are present. The computing devices 102₁-102ₙ may be any device capable of running code and/or containing logic, and in FIG. 1 are shown as being coupled via an edge server 104 to other remote networks and/or computing devices 106. Note that while an edge server 104 is shown within this example of FIG. 1, the technology described herein may apply to many other products and configurations, including one in which an edge server may not be present; indeed, as set forth above, the technology described herein concept may apply to a standalone machine, (e.g., with local user accounts) or a peer-to-peer network. Note that the edge server device 104 can be combined with the object store device 1024; they need not be separate entities. Although not shown in FIG. 1, it is understood that various other networking components may be present, e.g., routers, switches, hubs, modems, and hardware-based firewalls.

One of the computing devices (e.g., 102₄) is shown as maintaining an object store 108, which as described below, stores role template objects and network account objects, which may be created based upon those template objects; note that in an alternative implementation, the object store 108 may be distributed and/or replicated across multiple computing devices. For example, in an Active Directory® environment, each role template object (e.g., named UserRoleTemplate) may be created in the Active Directory® schema and maintained in the Active Directory® primary object store.

A new type of template object, named a role template object herein, provides for the concept of a role to be maintained in association with network account objects, including maintaining the association after creation. One way to store the settings in a role template object is to express them in XML, with the XML vocabulary defined by a schema. This enables interoperability with other systems, e.g., as an extension to a System Definition Model (which supports the Microsoft® Dynamic Systems Initiative). An Active Directory® template object may store this XML description of the role values.

Moreover, in addition to maintaining the association after creation, role template objects add capabilities that are not present in existing templates (that are presently used only for user account creation). Examples of such additional capabilities include the ability to specify an event action (e.g., a set of one or more tasks) to take when a network account is created, an event action to take when a network account is assigned to a different role, and/or an action to take when a network account object is deleted. In general, these situations correspond to events in the life of a network account, and thus terms used herein to refer to such concepts in general include lifecycle milestones, lifecycle event actions and lifecycle management. Further, changes to network account objects may be propagated to those network account objects as a group if their corresponding role template is modified.

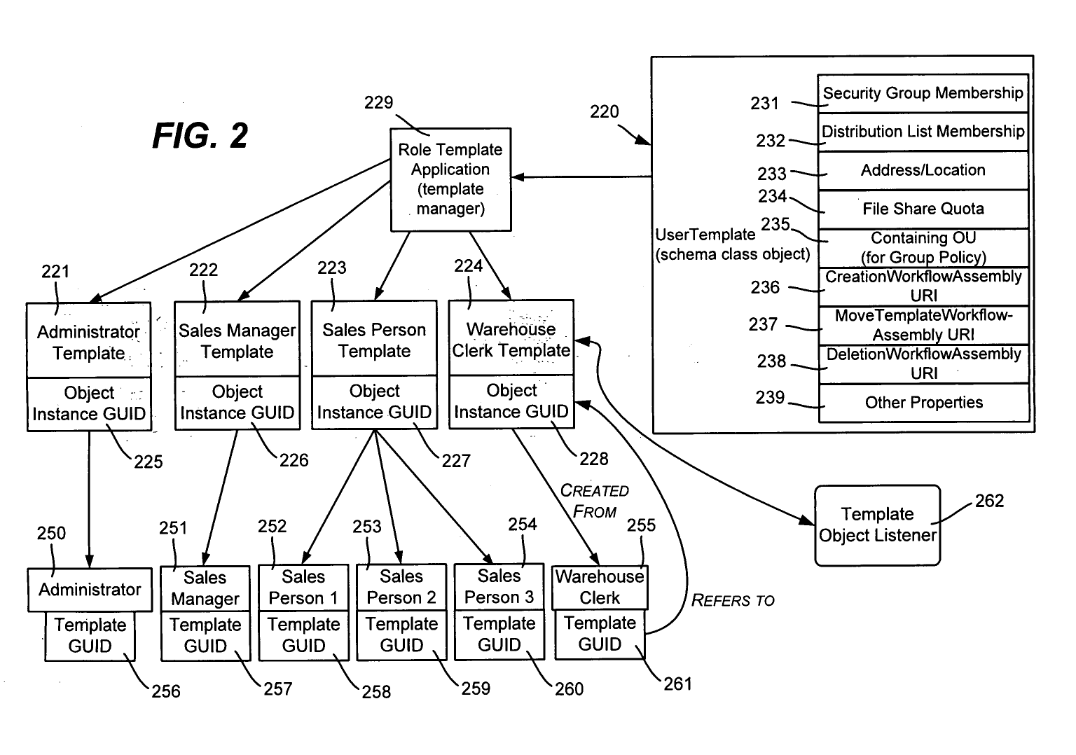

As generally represented in FIG. 2, which is directed to the concept of user account objects as an example of network account objects, a user template object 220 may be used to create role template objects 221-224, each with its own unique object instance identifier, e.g., in the form of GUIDs (Globally Unique Identifiers) 225-228, respectively. Note that four role template objects 221-224 are shown in this example, however as can be readily appreciated, there may be any practical number in a given networking environment.

Each role template object 221-224 is created with a number of attributes, which are filled in based on attribute types 231-239 defined in the user template object 220. For example, this may be accomplished via a template manager (editor) 229, such as an extension of a user/administration console that allows new role templates and network accounts to be created and managed, e.g., in a rich graphical user interface that lists network accounts in one sortable column and the role for each network account in an adjacent sortable column. The template manager 229 also may list tasks that may be performed on network account objects, e.g., including on multiple selected network account objects, such as all network account objects linked to a specific role. The application program 229 may allow administrators to choose from among typical role template objects, modify existing role template objects and create new role template objects (whether from scratch or based on an existing role template object, or based on an existing network account). Note that as described below, the act of modifying an existing role template object may result in the changes being propagated to the network account objects associated with that role template object, e.g., by the template manager 229. A default set of role template objects may be provided, e.g., including role template objects for common business and organizational roles that typical customers find useful, such as knowledge worker, sales person, manager, executive, student, volunteer, and the like.

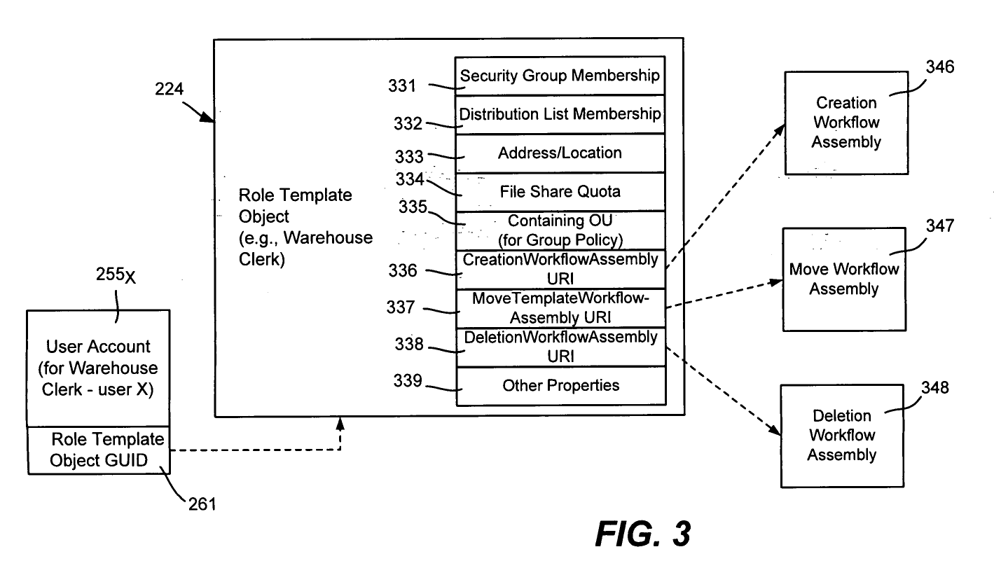

Further, the template manager 229 provides a mechanism to specify the action (a set of one or more tasks) to be taken for each lifecycle milestone of a network account object. FIG. 3 is a representation of the role template object 224, e.g., for a warehouse clerk, associated with (e.g., via the GUID 261) the user account object 255_{X} for a given warehouse clerk, user X.

For lifecycle management, the attributes in the role template object 224 include an action (e.g., a reference thereto) for each of the user lifecycle milestones, namely (in this user account-centric example) user account object creation 336, user account object moving (reassignment) 337, and user account object deletion 338. In general, these attributes identify the tasks to perform upon a milestone event occurring. Although it is feasible to store the set of tasks themselves in the user template objects 221-224, such as in the form of executable code, in the example of FIGS. 2 and 3 each these attributes 336-338 instead store a reference (e.g., a uniform resource identifier, or URI) to a task set (e.g., managed code assembly workflows 346-348), respectively, which may be invoked to perform the tasks. Note that as used herein, “task set,” “assembly” and “workflow” refer to any way to group one or more business logic objects into a collective unit, e.g., a set of one or more tasks that can be executed, however coded, and are not limited to managed code assemblies or to any more particular definitions of an assembly or workflow.

As also represented in FIG. 3, additional role template object attributes may store the security group memberships and distribution list memberships (corresponding to attribute locations 331 and 332) to be applied to new and reassigned users. There also may be attributes set for the role's address/location 333, and file share quota 334. Another attribute 335 may name the Active Directory® organizational unit (OU) in which new or reassigned users are to be created/moved; note that there may be group policy assigned to these organizational units, which may be managed by the same application 229 that creates and edits the role template objects 221-224. (Organizational units and group policy are described in U.S. Pat. Nos. 6,950,818 and 6,466,932, assigned to the assignee of the present invention.) Other attributes 339 may be present, e.g., to set default values for new network account objects such as location, department, and so on.

Returning to FIG. 2, an administrator thus may set up roles for various types of network entities such as users, each with their own user account object 250-255 (shown as administrator 250, sales manager 251, sales persons 252-254 and warehouse clerk 255). Each user account object 250-255 includes an identifier 256-261 (e.g., GUID) that refers back to the template object to which it is associated. For example, the Active Directory® schema description of a user (or other network) account object may be extended to add an attribute that holds a link to a role template object, such as called the role template objectLink. When a new account object is created by the template manager 229, its role template objectLink attribute is set to contain the identifier of the creating template; (e.g., because the Active Directory® uses GUIDs to uniquely name objects, the role template objectLink may contain the GUID of the creating template, forming a mapping/association between each account object and its role template object). In a configuration in which an account object may be associated with more than one role template object, multiple GUIDs or like identifiers may be used to map multiple associations. When an account object is moved or deleted, the template manager 229 will read the role template objectLink attribute, locate the named template, and invoke the move or deletion action contained in that template, as appropriate.

By way of an example of user account lifecycle management in a hypothetical company, a company administrator can set up each sales person user account 252-254 with an association with the corresponding role template object 223. The role template object 223 may, for example, contain attributes that assign new sales person user account objects to security groups A and B, and grant each user 50 MB of disk storage space for documents. In the event that this hypothetical company later decides to give sales people additional resource access, such as to also assign sales people to security group C and to increase the disk quota to 100 MB, the sales person template 223 is modified. Because the association is maintained after creation, the template manager 229 may propagate this change to the user account objects 252-254 that are currently associated with the sales person template 223.

Consider a further example in which this same company also has an employee role of sales manager with a corresponding template object 222 that assigns group membership in groups A, C, and D and rights to modify the tables of the sales tracking database. If an employee is promoted from sales person to sales manager, the user account administrator changes the template assignment for this person's user account object from the sales person template 223 to the sales manager template 222. As described below, as part of a move workflow, the template manager 229 may automatically give that user account object the new membership in group D and remove the membership in group B, while also granting the user account the privilege to update the sales database. For example, the move URI in the sales person template 223 may point to a workflow assembly that contains the remove-related membership tasks, while the move URI in the sales manager template 222 may point to an assembly that contains the tasks that add the appropriate memberships and privileges for the new role of sales manager.

In the event the employee leaves the company, the user account administrator deletes that user account object, e.g., the object 251. Via the deletion workflow assembly pointed to in the sales manager template 222, the template manager 229 takes appropriate deletion action, e.g., performs tasks to remove that account's security group memberships, its privileges in the sales database and to archive the former employee's documents and email that were associated with that user account.

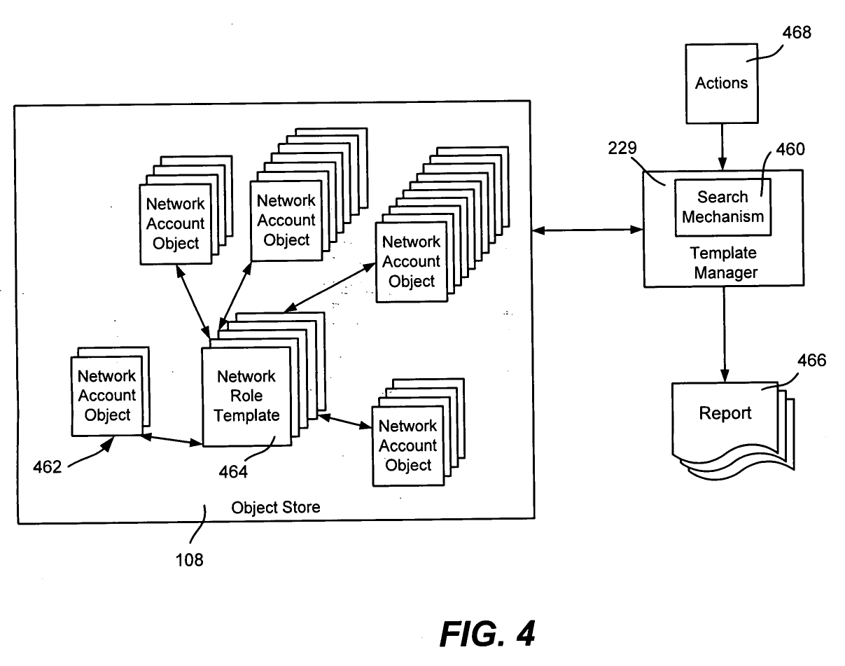

An additional capability facilitated by role template objects is to list network accounts and/or search for network accounts based on role membership, e.g., for viewing and reporting purposes, and for propagating changes thereto. For example, search and categorization may be performed to list the network accounts that meet a certain criteria, such as role, location, or group membership. As represented in FIG. 4, with respect to role-based searches, a search mechanism 460 (e.g., incorporated into or otherwise associated with the template manager 229) may be used to search the object store 108 to locate which network account objects (e.g., 462) are associated (e.g., via their links, which may be GUIDs) with a given role template object, e.g., role template 464, such as to generate displayable and/or printable reports 466. Moreover, because network accounts can be matched to roles via the role template objects, is also possible to apply actions 468 to the members of a role, such as to propagate changes and also to perform actions such as to “give all sales people a bonus.”

As can be readily appreciated, the association between network accounts and templates thus provides for a mechanism to locate and/or apply changes to a template to all accounts associated with that template. This one-to-many propagation allows a company to evolve without significant manual intervention. Further, the template object stores information about an event action that should be taken at each milestone of an account's lifecycle, e.g., account creation, account reassignment, and account removal. The actions (or pointers to those actions) stored in a role template object are modifiable so that roles can evolve with the growth and changes in a company. Actions may be modified by changing the code that performs the task set (e.g., in the workflow assemblies to which the role template object points), or by changing the URI to reference a different workflow assembly. Note that in a given network it is feasible to associate a network account with more than one role template object, whereby the appropriate actions of each role template object may be applied cumulatively. An arbitration mechanism or the like may be used to resolve conflicting actions.

One way to author actions for user lifecycle milestone events is to use Windows® Workflow Foundation, which provides a user-friendly authoring environment that is an extension of Visual Studio. Notwithstanding, because in one implementation the action set is invoked through a URI, any executable code may be invoked. For example, any managed code assembly may be named and used, and thus any of the managed code languages such as C# or VB.Net may be used to author lifecycle actions. In one example implementation, actions may be invoked using an InvokeAction method of an Irole template objectActions interface. This interface also defines an event, ActionResult, which is called when the action completes, and conveys the success or error status of the action. A callback method, ActionProgress, may be periodically called to inform the template manager 229 of the progress of the action. ActionProgress may have a reference parameter that may be set to cancel the action. Actions may be transacted so that any tasks that were performed are undone (rolled-back) if all tasks did not complete successfully, e.g., due to error or user cancellation.

A lifecycle event action is thus a sequence of tasks. Examples of tasks performed by a user account creation action may include creating an Active Directory® user account object and setting its attributes (properties) based on the template, creating a mailbox for the user, adding the user to the role template-listed security and distribution groups, creating a network share and applying the quota as defined in the template, assigning permissions to a website (e.g., a Sharepoint Services web site), updating a Human Resources database, and so on. Analogous tasks may be executed for user role reassignment, e.g., moving the user to a different organization unit, changing the group membership, changing the quota, granting permission to a database, and so forth. Examples of tasks likely to be performed on user deletion include removing the Active Directory® user account object, deleting the user's mailbox such as after archiving the user's email, removing the network share after archiving the user's documents, and so forth.

Turning to other aspects, user administrators may manually give network account objects memberships and privileges beyond those assigned by the user's template. Similarly, a user administrator may change or remove some of the memberships or other network account object configuration state. As a result, when such a network account object is deleted, and the template manager 229 attempts to run the deletion workflow defined by the user's template, some of the tasks within the deletion action set may not be successful because of the manual changes. In such an event, the deletion action may note the individual task failures and continue until all of the action's tasks have been attempted. The user administrator is then given a report as to the status of the deletion actions.

As can be readily appreciated, consistency is maintained as long as operations are launched from a common administration console. However, if other tools are used to make changes, then the relationship between a network account object and its role template may be lost. As represented in FIG. 2, a conformance service 262 may listen for modifications and restore changes as needed.

For example, in the event that a network account object is changed, e.g., by an administrator, one option is to run a service (e.g., continuously or periodically, such as daily) that makes sure that each network account continues to match the associated role template object's settings. Enforcement may be automatic, e.g., the service can restore the network account object to conform to the role template object. Alternatively, certain network accounts may be flagged so that they will be allowed to have settings that deviate from their associated template, e.g., by setting an “enforce-compliance” attribute to FALSE. Auditing may be performed to report which accounts are not in compliance, e.g., including a listing of who made the non-conforming changes and when they made them, and/or as well as recording the name of the person who set the enforce-compliance attribute to FALSE.

There also may be a “default” template for network account objects that have been manually modified such that they no longer correspond to the settings embodied in their former template. For example, before assigning the network account object to the default template, the template manager 229 may compare the modified user account object to the other templates to see if there was a match. When a network account object associated with the default template is deleted, a notification may be given to the administrator, e.g., to the effect that there may be resources that need to be manually deleted because the template manager 229 may not track the manual changes.

Another aspect is with respect to extensibility, in which the template system may be designed to allow third parties or IT administrators to add additional lifecycle operations. For example, a Customer Relations Management (CRM) system vendor may add a creation task that would add the new user to the CRM system database. This new task may be run after the role's included creation tasks. In other words, it is feasible for a role template to store a sequence of URIs to be performed at each lifecycle action, with the ability to add URIs to the end of this sequence, or even insert them elsewhere in the sequence.

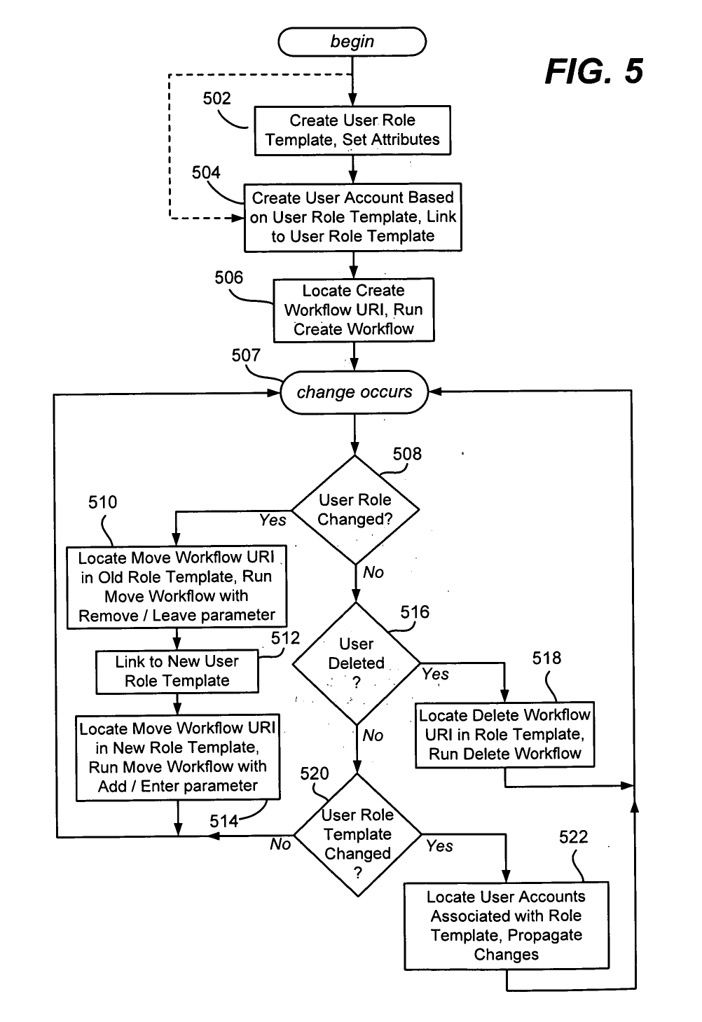

Turning to an explanation of the example operation of a template manager 229 and workflows with reference to the flow diagram of FIG. 5, step 502 represents the administrator's creation of a role template object, including setting the attributes to match a particular role and thus assign a collection of attributes to a particular category of users. As described above, the template and its workflows (in assemblies) are used to manage the lifecycle of network account objects. Thus, in one example implementation, setting the attributes includes setting the URIs to the assemblies containing the create, move and delete user workflows. Note that the URI may reference the same create workflow assembly for different role template objects, but it is feasible to specify a different create assembly per role so that different roles may have different workflows invoked for creation of the account objects. Additionally, it is feasible to have a single assembly for some or all templates, for example with the template manager passing a parameter to indicate which template is invoking the URI. In this alternative, an assembly thus may perform different tasks based on the value of this parameter.

Step 504 represents an example of creating a network (e.g., a user) account and linking the account (e.g., via a GUID-based or similar association) to the role template object created in step 502. Note that as indicated via the dashed line, step 502 need not be performed for each user or other network entity, but rather only occurs upon creation of a role template object for a new class of network accounts. For example, step 504 may begin the process for a new user that links to an existing role template object; the administrator selects the template that will be used as the basis for creating the new user account object. In any event, in this example implementation, the new user account object has an attribute that identifies the associated role template object, and subsequent actions for that the user account are able to be invoked via the workflow assemblies identified in that template.

Step 506 represents looking up the URI in the attributes to the create workflow assembly, and running the create workflow for the user created at step 504. Note that part of the creation at step 504 may be performed via the workflow, e.g., tasks such as Active Directory® object creation, mailbox creation, document folder creation, quota setting and so forth may be accomplished as part of the create workflow at step 506.

Step 507 represents some lifecycle or role-related change occurring, typically in response to some administrator action, but possibly in response to an automated process, a timeout condition, or some other event or the like. Note that such a change need not correspond to simple edits, such as renaming, changing the user's phone number, and so on, which may be done directly on the user account object and are not represented by step 507. Further note that step 507 may occur long (e.g., days, weeks, months or years) after creation, and that the steps of FIG. 5 are not necessarily performed in the order shown nor are the changes necessarily evaluated one after the other until a match is found, e.g., there may be an event handler that triggers different code for each type of change.

As described above, the template manager 229 allows an administrator to assign a user account object to a different role template. If this is the change that occurred, as evaluated by step 508, a move/reassignment action takes place. As represented via steps 510 and 514, the move workflow on both the old role template object and the new role template object may be invoked in that order (old first, then new). A parameter to the action-invoking function may be used to notify each workflow as to whether the role was being removed for that account (leaving the old role) or added for that account (entering the new role). In this manner, the old role template object may have its reassignment action invoked in remove mode so it may do whatever removal cleanup was required. The new template's reassignment action may be invoked in add mode so that a new configuration may be performed. As also represented by step 512, the role template object attribute is updated to point to the new template.

If not a move, step 516 evaluate whether the change corresponds to deletion of an account. As described above and represented via step 518, when the administrator deletes an account object, the application that performs the deletion reads the role template name from the object, and then performs the deletion action. In one example implementation, the deletion action is performed by reading the name (e.g., URI) of the deletion workflow assembly from the role template object. Via that URI, the named workflow will be invoked to do the deletion action (task or tasks).

Another possible change occurs when a role template object is modified, as detected via step 520. In such an event, the template manager 229 locates (e.g., via the search mechanism 460 of FIG. 4) the entire set of account objects linked to that role template object, and applies the change or changes to those account objects (step 522). By way of example, if an administrator adds access to the marketing database to an “Engineer” role template, then all user account objects that are associated with the Engineer role template are located and updated so as to be given access to the marketing database. For example, based on the template's GUID stored in a user account object's attributes, a change query hook may monitor for changes to the role template objects, and when detected, execute code to update any user account objects that are associated with that changed role template object. Account objects may be located via a search for those account objects that contain an identifier (e.g., GUID value) in the appropriate attribute field that matches that of the changed role template object. A similar search may be conducted to locate the accounts currently associated with a role. Note that the currently associated account objects are not necessarily those that were created from the roles, as a network account may change roles, and indeed, a network account object may be modified such that it no longer matched any existing role.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable media having computer-executable instructions, which when executed perform steps, comprising:
associating a network account object with a role template object;
maintaining action information in the role template object; and
taking the action, based upon the action information, in response to a change in a lifecycle of the network account object.

2. The computer-readable media of claim 1 further comprising, propagating data corresponding to a change made to the role template object to the network account object associated with the role template object.

3. The computer-readable media of claim 2 wherein propagating the change comprises locating the network account object based on an identifier of the role template object that is maintained as an attribute of the network account object.

4. The computer-readable media of claim 1 wherein the action information includes a reference to a create task set comprising one or more tasks, and wherein taking the action comprises running the create task set as part of creation of the network account object.

5. The computer-readable media of claim 1 wherein the action information includes a reference to a delete task set comprising one or more tasks, and wherein taking the action comprises running the delete task set as part of deletion of the network account object.

6. The computer-readable media of claim 1 wherein the action information includes a reference to a move task set comprising one or more tasks, and wherein taking the action comprises running at least one move task set as part of a reassignment of the network account object to a different role template object, and further comprising associating the network account object with the different role template object.

7. The computer-readable media of claim 6 wherein running the at least one move task set comprises running a move task set of the role template object to which the network account object was associated, and running a move task set of the different role template object.

8. The computer-readable media of claim 7 wherein running the move task set of the role template object to which the network account object was associated includes passing a parameter indicating that an association with that role template object is being removed, and wherein running the move task set of the different role template object comprises passing a parameter indicating that an association with the different role template is being added.

9. In a computing environment, a system comprising:
a plurality of role template objects, each role template object including information corresponding to at least one lifecycle event action;
a plurality of network account objects, each network account object associated with at least one role template object; and
a template manager coupled to the role template objects and to the network account objects, the template manager causing a lifecycle event action to be taken in response to detection of a lifecycle event related to a network account object.

10. The system of claim 9 wherein the action information comprises at least one member of a set, the set containing: a uniform resource identifier of a create task set comprising one or more tasks corresponding to a create lifecycle event, a uniform resource identifier of a move task set comprising one or more tasks corresponding to a move lifecycle event, and a uniform resource identifier of a delete task set comprising one or more tasks corresponding to a delete lifecycle event.

11. The system of claim 9 wherein each network account object is associated with at least one role template object via an identifier of the role template object maintained in an attribute in each network account object.

12. The system of claim 11 wherein the network account objects and role template objects are maintained as objects in an Active Directory® object store, wherein the network account objects comprise user account objects, service account objects, or computer account objects, or any combination thereof, and wherein the identifier of the role template object maintained in an attribute in each network account object comprises a globally unique identifier.

13. The system of claim 11 further comprising a search mechanism that locates which network account objects are associated with a selected role template object based on an identifier of that selected role template object.

14. The system of claim 13 further comprising means for propagating at least one change to the network account objects that are associated with the selected role template object.

15. The system of claim 13 further comprising means for generating a report for the network account objects that are associated with the selected role template object.

16. The system of claim 9 further comprising a compliance mechanism that monitors at least one network account object as to whether each monitored network account object complies with attribute data of its associated role template object.

17. In a computing environment having a computer network, a method comprising:
maintaining an association between network account objects and a role template object;
locating the network account objects based on the association; and
performing an administrative function on the network account objects that were located based on the association.

18. The method of claim 17 wherein performing the administrative function comprises performing at least one function of a set, the set containing: generating a report, propagating at least one change to the network account objects, and auditing a change to any network account object that causes the network account object to no longer comply with attribute data in the role template object.

19. The method of claim 17 further comprising, detecting a lifecycle event related to a network account object that is associated with a role template object, and referencing the role template object to take an action corresponding to that lifecycle event.

20. The method of claim 19 wherein referencing the role template object to take the action comprises locating the role template object, and locating an identifier in the role template object of a task set comprising one or more tasks that corresponds to the lifecycle event to run the task set to take the action.
